(19) United States
(12) Patent Application Publication
(10) Pub. No.: US 2015/0167130 A1
(43) Pub. Date: Jun. 18, 2015

(54) Composite Pistons for Rotary Engines

(71) Applicant: Airbus Defence and Space GmbH, Ottobrunn (DE)

(72) Inventors: Juergen STEINWANDEL, Uhldingen-Muehlhofen (DE); Blanka LENCZOWSKI, Neubiberg (DE); Ernst SIGMUND, Cottbus (DE); Marko GOLLASCH, Cottbus (DE)

(21) Appl. No.: 14/561,347

(22) Filed: Dec. 5, 2014

(30) Foreign Application Priority Data
Dec. 6, 2013 (EP) 13005682.3-1353

(51) Int. Cl. C22C 32/00; B23K 26/34; B23K 26/00; B23K 15/00; B23K 10/02; C22F 1/043; C22F 1/18; B22F 3/105; B22F 3/02; B22F 3/20; B22F 3/17; B22D 21/00; C22F 1/02; C22C 14/00; C22C 21/02; F02F 3/00

(52) U.S. Cl. CPC C22C 32/0036; F02F 3/003; B23K 26/345; B23K 26/0018; B23K 15/0086; B23K 10/027; C22F 1/043; C22F 1/183; B22F 3/1055; B22F 3/02; B22F 3/20; B22F 3/17; B22D 21/005; B22D 21/007; C22F 1/02; C22C 14/00; C22C 21/02; C22C 32/0031; C22C 32/0084; B33Y 10/00

(57) ABSTRACT

A light metal material having a tensile strength of >180 MPa at room temperature is provided, as well as a method for producing such a light metal material and the use of such a light metal material as a piston component in a rotary piston engine.

### FIELD OF THE INVENTION

Exemplary embodiments of the present invention relate to a light metal material having a tensile strength of ≧180 MPa at room temperature, a method for manufacturing such a light metal material and the use of such a light metal material as a piston component in a rotary piston engine.

### BACKGROUND OF THE INVENTION

Composite pistons are known from reciprocating piston engine technology and are generally used when the use of pure light metal pistons is impossible for thermal reasons. Such composite pistons have a piston skirt consisting of a light metal alloy and the part facing the combustion chamber is made of an iron base alloy. The force is transferred to the crankshaft by way of the piston pin and piston rod. In rotary pistons, composite pistons are not at present the state of the art. Primarily iron base alloys are used here as plunger pistons. The internal gearing is usually hardened, e.g., by nitriding in the case of case-hardened steel or carburizing in the case of a cast steel. The internal gearing mediates the force/torque transfer to an eccentric shaft.

The aluminum and titanium light metals may be considered as materials for the light metal component for composite pistons. These light metal components can be constructed by conventional forging or casting methods, by extrusion using powder metallurgy methods, by powder metallurgy methods such as powder bed methods, laser or electron beam methods, etc. or non-powder metallurgical generative methods such as laser or plasma wire methods, etc.

However, the light metal components produced in this manner have only inadequate strength values, so that they are not suitable as light components of composite pistons for rotary piston engines.

It would thus be desirable to provide a light metal material which would have improved strength properties in comparison with traditional light metal materials. Furthermore, it is desirable to provide a light metal material that can be used as a material for the light metal component of composite pistons for rotary piston engines. It is also desirable to achieve a reduction in the piston weight and thus an improvement in the power/weight ratio of the rotary piston.

Therefore, exemplary embodiments of the present invention are directed to a light metal material having improved strength values in comparison with traditional light metal materials. Exemplary embodiments of the present invention are also directed to a light metal material used as a material for the light metal component of composite pistons for rotary piston engines. Furthermore, the light metal material of the present invention leads to a low piston weight and thus contributes toward an improvement in the power/weight ratio of the rotary piston. Exemplary embodiments of the present invention are also directed to a method for manufacturing such a light metal material, particularly one having a low manufacturing cost.

### SUMMARY OF THE INVENTION

Accordingly, a first subject matter of the present invention is a light metal material having a tensile strength of ≧180 MPa at room temperature, determined according to ISO 527-2, the light metal material comprising

a) an aluminum or titanium alloy and
b) nanoparticles distributed in the aluminum or titanium alloy in an amount of 0.1 to 15.0% by weight, based on the total weight of the light metal material.

The light metal material according to the invention is suitable as a material for the light metal component of composite pistons for rotary piston engines. Another advantage is that the light metal material has improved strength values. Another advantage is that the light metal material results in a low piston weight and thus permits an improvement in the power/weight ratio of the rotary piston. Another advantage is that the light metal material can be manufactured with a low manufacturing cost.

For example, a) the aluminum alloy comprises as additional alloy components at least one component selected from the group consisting of silicon (Si), scandium (Sc), copper (Cu), magnesium (Mg), nickel (Ni), iron (Fe), vanadium (V), titanium (Ti), zirconium (Zr), ytterbium (Y), manganese (Mn), hafnium (Hf), niobium (Nb), tantalum (Ta) or mixtures thereof or b) the titanium alloy comprises, as an additional alloy component, at least one component selected from the group consisting of aluminum (Al), vanadium (V) or mixtures thereof.

For example, the light metal material is an aluminum alloy comprising aluminum (Al), magnesium (Mg) and silicon (Si).

For example, the nanoparticles have a diameter of 10 to 1000 nm, preferably 15 to 500 nm, more preferably 20 to 250 nm and most preferably 25 to 100 nm.

For example, the light metal material comprises the nanoparticles in an amount of 0.1 to 12.0% by weight, based on the total weight of the light metal material.

For example, the nanoparticles comprise a material selected from the group consisting of carbon, aluminum oxide, zirconium oxide, yttrium-stabilized zirconium oxide, cerium oxide, lanthanum oxide and mixtures thereof. The nanoparticles comprising carbon are preferably selected from the group consisting of fullerenes, carbon nanotubes, graphanes, graphenes, graphites and mixtures thereof.

For example, the light metal material has a tensile strength of ≧90 MPa, determined according to ISO 527-2, at a temperature of 250° C.

For example, the light metal material is obtained by the method described herein.

The present invention also provides a method for manufacturing the light metal material, the method comprising:

a) Providing an aluminum or titanium alloy,
b) Providing nanoparticles,
c) Bringing the aluminum or titanium alloy from step a) in contact with the nanoparticles from step b) for manufacturing a light metal material comprising the aluminum or titanium alloy and nanoparticles distributed therein and
d) Heat treatment of the light metal material obtained in step c) in a temperature range of 100 to 1200° C.

For example, the manufacture of the light metal material in step c) is carried out by a method selected from the group consisting of forging methods, casting methods, powder metallurgical extrusion methods, powder metallurgical generative methods such as, for example, additive layer manufacturing (ALM), powder bed methods, laser beam methods, electron beam methods, laser powder methods or laser jet methods and non-powder-metallurgy methods such as laser wire methods or plasma wire methods.

For example, the heat treatment from step d) is carried out under a protective gas or in a vacuum for a period of 10 minutes to 50 hours and/or in a plurality of steps and/or increments.

Likewise the present invention relates to the use of the light metal material as a piston component in a rotary piston engine, for example, in a drive or a turbine in a passenger transport vehicle, in particular in aircraft such as passenger airplanes and unmanned aircraft.

### DETAILED DESCRIPTION OF THE INVENTION

The present invention relates to a light metal material having a tensile strength of ≧180 MPa, determined according to ISO 527-2 at room temperature, wherein the light metal material comprises

a) an aluminum or titanium alloy and
b) nanoparticles distributed in the aluminum or titanium alloy in an amount of 0.1 to 15.0% by weight, based on the total weight of the light metal material.

One requirement of the present invention is thus that the light metal material comprises an aluminum or titanium alloy.

The light metal material comprises an aluminum alloy, for example.

In one embodiment of the present invention, the aluminum alloy comprises, as an additional alloy component, at least one component selected from the group consisting of silicon (Si), scandium (Sc), copper (Cu), magnesium (Mg), nickel (Ni), iron (Fe), vanadium (V), titanium (Ti), zirconium (Zr), ytterbium (Y), manganese (Mn), hafnium (Hf), niobium (Nb), tantalum (Ta) or mixtures thereof.

For example, the aluminum alloy comprises at least two components as an additional alloy component, for example, two components selected from the group consisting of silicon (Si), scandium (Sc), copper (Cu), magnesium (Mg), nickel (Ni), iron (Fe), vanadium (V), titanium (Ti), zirconium (Zr), ytterbium (Y), manganese (Mn), hafnium (Hf), niobium (Nb), tantalum (Ta) or mixtures thereof.

Alternatively, the aluminum alloy comprises as an additional alloy component at least three components, for example, three or four components selected from the group consisting of silicon (Si), scandium (Sc), copper (Cu), magnesium (Mg), nickel (Ni), iron (Fe), vanadium (V), titanium (Ti), zirconium (Zr), ytterbium (Y), manganese (Mn), hafnium (Hf), niobium (Nb), tantalum (Ta) or mixtures thereof.

In one specific embodiment of the present invention the aluminum alloy comprises at least one component as an additional alloy component, for example, two or three components selected from the group consisting of silicon (Si), copper (Cu), magnesium (Mg), nickel (Ni) and iron (Fe). The aluminum alloy preferably comprises as the additional alloy component three or four components selected from the group consisting of silicon (Si), copper (Cu), magnesium (Mg), nickel (Ni) and iron (Fe).

The aluminum alloy comprises aluminum (Al) and the at least one alloy component, for example, two or three or four components selected from the group consisting of silicon (Si), scandium (Sc), copper (Cu), magnesium (Mg), nickel (Ni), iron (Fe), vanadium (V), titanium (Ti), zirconium (Zr), ytterbium (Y), manganese (Mn), hafnium (Hf), niobium (Nb), tantalum (Ta) or mixtures thereof preferably in a total amount of at least 88.0% by weight, based on the total weight of the aluminum alloy. For example, the aluminum alloy comprises aluminum (Al) and the at least one alloy component, for example, two or three or four components selected from the group consisting of silicon (Si), scandium (Sc), copper (Cu), magnesium (Mg), nickel (Ni), iron (Fe), vanadium (V), titanium (Ti), zirconium (Zr), ytterbium (Y), manganese (Mn), hafnium (Hf), niobium (Nb), tantalum (Ta) or mixtures thereof, preferably in a total amount of at least 89.0% by weight, preferably a total amount of at least 90.0% by weight and most preferably a total amount of at least 91.0% by weight, based on the total weight of the aluminum alloy. In one specific embodiment of the present invention, the aluminum alloy comprises aluminum (Al) and the at least one alloy component, for example, two or three or four components selected from the group consisting of silicon (Si), scandium (Sc), copper (Cu), magnesium (Mg), nickel (Ni), iron (Fe), vanadium (V), titanium (Ti), zirconium (Zr), ytterbium (Y), manganese (Mn), hafnium (Hf), niobium (Nb), tantalum (Ta) or mixtures thereof, preferably in a total amount of at least 92.0% by weight, preferably a total of at least 94.0% by weight, more preferably a total of at least 96.0% by weight, and most preferably a total of at least 98.0% by weight, based on the total weight of the aluminum alloy.

In one specific embodiment of the present invention, the aluminum alloy comprises aluminum (Al) and the at least one alloy component, for example, two or three or four components selected from the group consisting of silicon (Si), scandium (Sc), copper (Cu), magnesium (Mg), nickel (Ni), iron (Fe), vanadium (V), titanium (Ti), zirconium (Zr), ytterbium (Y), manganese (Mn), hafnium (Hf), niobium (Nb), tantalum (Ta) or mixtures thereof preferably in a total amount of 88.0 to 100.0% by weight or a total amount of 88.0 to 99.99% by weight, based on the total weight of the aluminum alloy. For example, the aluminum alloy comprises aluminum (Al) and the at least one alloy component, for example, two or three or four components selected from the group consisting of silicon (Si), scandium (Sc), copper (Cu), magnesium (Mg), nickel (Ni), iron (Fe), vanadium (V), titanium (Ti), zirconium (Zr), ytterbium (Y), manganese (Mn), hafnium (Hf), niobium (Nb), tantalum (Ta) or mixtures thereof, preferably a total amount of 88.0 to 99.95% by weight preferably 88.0 to 99.5% by weight and most preferably 88.0 to 99.45% by weight, based on the total weight of the aluminum alloy. In one specific embodiment of the present invention, the aluminum alloy comprises aluminum (Al) and the at least one alloy component, for example, two or three or four components selected from the group consisting of silicon (Si), scandium (Sc), copper (Cu), magnesium (Mg), nickel (Ni), iron (Fe), vanadium (V), titanium (Ti), zirconium (Zr), ytterbium (Y), manganese (Mn), hafnium (Hf), niobium (Nb), tantalum (Ta) or mixtures thereof, preferably a total amount of 90.0 to 99.5% by weight, based on the total weight of the aluminum alloy. Alternatively, the aluminum alloy comprises aluminum (Al) and the at least one alloy component, for example, two or three or four components selected from the group consisting of silicon (Si), scandium (Sc), copper (Cu), magnesium (Mg), nickel (Ni), iron (Fe), vanadium (V), titanium (Ti), zirconium (Zr), ytterbium (Y), manganese (Mn), hafnium (Hf), niobium (Nb), tantalum (Ta) or mixtures thereof, preferably a total amount of 98.0 to 99.95% by weight, based on the total weight of the aluminum alloy.

In one specific embodiment of the present invention, the aluminum alloy comprises the at least one alloy component, which is selected from the group consisting of silicon (Si), scandium (Sc), copper (Cu), magnesium (Mg), nickel (Ni), iron (Fe), vanadium (V), titanium (Ti), zirconium (Zr), ytterbium (Y), manganese (Mn), hafnium (Hf), niobium (Nb), tantalum (Ta) or mixtures thereof in an amount of 0.5 to 35.0% by weight per element, based on the total weight of the aluminum alloy. For example, the aluminum alloy comprises the at least one alloy component, which is selected from the group consisting of silicon (Si), scandium (Sc), copper (Cu), magnesium (Mg), nickel (Ni), iron (Fe), vanadium (V), titanium (Ti), zirconium (Zr), ytterbium (Y), manganese (Mn), hafnium (Hf), niobium (Nb), tantalum (Ta) or mixtures thereof, in an amount of 0.5 to 27.0% by weight per element, based on the total weight of the aluminum alloy.

Additionally or alternatively, the aluminum alloy comprises the at least one alloy component, for example, two or three or four components selected from the group consisting of silicon (Si), scandium (Sc), copper (Cu), magnesium (Mg), nickel (Ni), iron (Fe), vanadium (V), titanium (Ti), zirconium (Zr), ytterbium (Y), manganese (Mn), hafnium (Hf), niobium (Nb), tantalum (Ta) or mixtures thereof in a total amount of 5.0 to 40.0% by weight, based on the total weight of the aluminum alloy. For example, the aluminum alloy comprises the at least one alloy component, for example, two or three or four components selected from the group consisting of silicon (Si), scandium (Sc), copper (Cu), magnesium (Mg), nickel (Ni), iron (Fe), vanadium (V), titanium (Ti), zirconium (Zr), ytterbium (Y), manganese (Mn), hafnium (Hf), niobium (Nb), tantalum (Ta) or mixtures thereof, in a total amount of 10.0 to 30.0% by weight, based on the total weight of the aluminum alloy.

In specific embodiment of the present invention, the aluminum alloy comprises aluminum (Al) in an amount of 60.0 to 95.0% by weight, based on the total weight of the aluminum alloy. For example, the aluminum alloy comprises aluminum (Al) in an amount of 70.0 to 90.0% by weight and preferably in an amount of 70.0 to 88.0% by weight, based on the total weight of the aluminum alloy.

To obtain an aluminum alloy having a high strength, it is advantageous for the aluminum alloy to comprise at least one additional alloy component, for example, two, three or four components, selected from the group consisting of silicon (Si), copper (Cu), magnesium (Mg), nickel (Ni) and iron (Fe) in a certain amount.

The aluminum alloy preferably comprises the at least one additional alloy component, for example, two or three or four components selected from the group consisting of silicon (Si), copper (Cu), magnesium (Mg), nickel (Ni) and iron (Fe) in a total amount of 5.0 to 40.0% by weight, based on the total weight of the aluminum alloy. In one specific embodiment of the present invention, the aluminum alloy comprises the at least one additional alloy component, for example, two or three or four components selected from the group consisting of silicon (Si), copper (Cu), magnesium (Mg), nickel (Ni) and iron (Fe) in a total amount of 10.0 to 30.0% by weight total and preferably in an amount of 12.0 to 30.0% by weight, based on the total weight of the aluminum alloy.

The aluminum alloy comprises, for example, silicon (Si) in an amount of more than 8.0% by weight, based on the total weight of the aluminum alloy. In one embodiment of the present invention, the aluminum alloy comprises silicon (Si) in an amount of 8.0 to 30.0% by weight, preferably in an amount of 10.0 to 30.0% by weight, more preferably in an amount of 10.0 to 27.0% by weight and most preferably in an amount of 11.0 to 26.0% by weight, based on the total weight of the aluminum alloy. Addition of silicon (Si) to the alloy has the advantage in particular that it contributes toward an improvement in the tensile strength.

Additionally or alternatively, the aluminum alloy comprises copper (Cu) in an amount of 0.5 to 10.0% by weight, based on the total weight of the aluminum alloy. For example, the aluminum alloy comprises copper (Cu) in an amount of 0.5 to 7.0% by weight and preferably in an amount of 0.8 to 5.0% by weight, based on the total weight of the aluminum alloy. Addition of copper (Cu) to the alloy has the advantage in particular that it contributes to the strength at room temperature and the strength at elevated temperatures and toward an improvement in the tensile strength.

In one embodiment of the present invention, the aluminum alloy comprises magnesium (Mg) in an amount of 0.5 to 2.5% by weight, based on the total weight of the aluminum alloy. For example, the aluminum alloy comprises magnesium (Mg) in an amount of 0.5 to 2.0% by weight and preferably in an amount of 0.8 to 1.5% by weight, based on the total weight of the aluminum alloy. Addition of magnesium (Mg) to the alloy has the advantage in particular that the specific density is reduced.

Additionally or alternatively, the aluminum alloy comprises nickel (Ni) in an amount of 0.5 to 4.0% by weight, based on the total weight of the aluminum alloy. The aluminum alloy comprises, for example, nickel (Ni) in an amount of 0.5 to 3.0% by weight and preferably in an amount of 0.8 to 2.5% by weight, based on the total weight of the aluminum alloy. Addition of nickel (Ni) to the alloy has the advantage in particular that the thermal stability and strength are improved.

In one embodiment of the present invention, the aluminum alloy comprises iron (Fe) in an amount of 1.0 to 8.0% by weight, based on the total weight of the aluminum alloy. For example, the aluminum alloy comprises iron (Fe) in an amount of 2.0 to 7.0% by weight and preferably in an amount of 4.0 to 6.0% by weight, based on the total weight of the aluminum alloy. Addition of iron (Fe) to the alloy has the advantage in particular that the thermal stability and strength are improved.

In one embodiment of the present invention, the light metal material comprises an aluminum alloy comprising aluminum (Al), magnesium (Mg) and silicon (Si).

The light metal material comprises, for example, an aluminum alloy comprising aluminum (Al), magnesium (Mg), copper (Cu), silicon (Si) and nickel (Ni). The light metal material preferably comprises an aluminum alloy consisting of aluminum (Al), magnesium (Mg), copper (Cu), silicon (Si) and nickel (Ni). More preferably the light metal material comprises an aluminum alloy selected from the group consisting of AlSi₁₂CuMgNi, AlSi₁₈CuMgNi and AlSi₁₂Cu₄Ni₂Mg.

Alternatively, the light metal material comprises an aluminum alloy, comprising aluminum (Al), magnesium (Mg), copper (Cu) and silicon (Si). The light metal material preferably comprises an aluminum alloy consisting of aluminum (Al), magnesium (Mg), copper (Cu) and silicon (Si). Even more preferably the light metal material comprises an aluminum alloy selected from AlSi₁₇Cu₄Mg and AlSi₂₅Cu₄Mg.

Alternatively, the light metal material comprises an aluminum alloy comprising aluminum (Al), silicon (Si), iron (Fe) and nickel (Ni). The light metal material preferably comprises an aluminum alloy consisting of aluminum (Al), silicon (Si), iron (Fe) and nickel (Ni). Even more preferably the light metal material comprises AlSi₂₀Fe₅Ni₂ as the aluminum alloy.

In one embodiment of the present invention, the light metal material comprises a titanium alloy.

In one embodiment of the present invention, the titanium alloy comprises as an additional alloy component at least one component selected from the group consisting of aluminum (Al), vanadium (V) or mixtures thereof.

For example, the titanium alloy comprises aluminum (Al) or vanadium (V) as an additional alloy component. Alternatively, the titanium alloy comprises aluminum (Al) and vanadium (V) as an additional alloy component.

The titanium alloy comprises titanium (Ti) and the at least one additional alloy component, which is selected from the group consisting of aluminum (Al), vanadium (V) or mixtures thereof, preferably in a total amount of at least 88.0% by weight, based on the total weight of the titanium alloy. For example, the titanium alloy comprises titanium (Ti) and the at least one additional alloy component, which is selected from the group consisting of aluminum (Al), vanadium (V) or mixtures thereof, preferably in a total amount of at least 89.0% by weight, preferably a total amount of at least 90.0% by weight and most preferably a total amount of at least 91.0% by weight, based on the total weight of the titanium alloy. In one embodiment of the present invention, the titanium alloy comprises titanium (TI) and the at least one additional alloy component, which is selected from the group consisting of aluminum (Al), vanadium (V) or mixtures thereof, preferably in a total amount of at least 92.0% by weight, preferably a total of at least 94.0% by weight, more preferably a total of at least 96.0% by weight and most preferably a total of at least 98.0% by weight, based on the total weight of the titanium alloy.

In one embodiment of the present invention, the titanium alloy comprises titanium (Ti) and the at least one additional alloy component, which is selected from the group consisting of aluminum (Al), vanadium (V) or mixtures thereof, preferably in a total amount of 88.0 to 100.0% by weight or a total amount of 88.0 to 99.99% by weight, based on the total weight of the titanium alloy. For example, the titanium alloy comprises titanium (Ti) and the at least one additional alloy component, which is selected from the group consisting of aluminum (Al), vanadium (V) or mixtures thereof, preferably in a total amount of 88.0 to 99.95% by weight preferably 88.0 to 99.5% by weight and most preferably 88.0 to 99.45% by weight, based on the total weight of the titanium alloy. In one embodiment of the present invention, the titanium alloy comprises titanium (Ti) and the at least one additional alloy component, which is selected from the group consisting of aluminum (Al), vanadium (V) or mixtures thereof preferably in a total amount of 90.0 to 99.5% by weight, based on the total weight of the titanium alloy. Alternatively, the titanium alloy comprises titanium (Ti) and the at least one additional alloy component, which is selected from the group consisting of aluminum (Al), vanadium (V) or mixtures thereof preferably in a total amount of 98.0 to 99.95% by weight, based on the total weight of the titanium alloy.

In one embodiment of the present invention, the titanium alloy comprises the at least one additional alloy component, which is selected from the group consisting of aluminum (Al), vanadium (V) or mixtures thereof, in an amount of 0.5 to 10.0% by weight per element based on the total weight of the titanium alloy. For example, the titanium alloy comprises titanium (Ti) and the at least one additional alloy component, which is selected from the group consisting of aluminum (Al), vanadium (V) or mixtures thereof in an amount of 1.0 to 8.0% by weight per element based on the total weight of the titanium alloy.

Additionally or alternatively, the titanium alloy comprises the at least one additional alloy component, which is selected from the group consisting of aluminum (Al), vanadium (V) or mixtures thereof in a total amount of 2.0 to 15.0% by weight, based on the total weight of the titanium alloy. For example, the titanium alloy comprises the at least one additional alloy component, which is selected from the group consisting of aluminum (Al), vanadium (V) or mixtures thereof in a total amount of 5.0 to 12.0% by weight, based on the total weight of the titanium alloy.

In one embodiment of the present invention, the titanium alloy comprises titanium (Ti) in an amount of 85.0 to 98.0% by weight, based on the total weight of the titanium alloy. For example, the titanium alloy comprises titanium (Ti) in an amount of 88.0 to 95.0% by weight and preferably in an amount of 88.0 to 92.0% by weight, based on the total weight of the titanium alloy.

To obtain a titanium alloy having a high strength, it is advantageous that the titanium alloy comprises aluminum (Al) and/or vanadium (V) preferably aluminum (Al) and vanadium (V) in a certain amount.

For example, the titanium alloy comprises aluminum (Al) in an amount of more than 2.0% by weight, based on the total weight of the titanium alloy. In one embodiment of the present invention, the titanium alloy comprises aluminum (Al) in an amount of 2.0 to 10.0% by weight preferably in an amount of 3.0 to 10.0% by weight, more preferably in an amount of 4.0 to 9.0% by weight and most preferably in an amount of 4.0 to 8.0% by weight, based on the total weight of the titanium alloy. Addition of aluminum (Al) to the alloy has the advantage in particular that the specific density is reduced and the strength is increased.

Additionally or alternatively, the titanium alloy comprises vanadium (V) in an amount of 1.0 to 8.0% by weight, based on the total weight of the titanium alloy. For example, the titanium alloy comprises vanadium (V) in an amount of 1.5 to 7.0% by weight and preferably in an amount of 2.0 to 6.0% by weight, based on the total weight of the titanium alloy. Addition of vanadium (V) to the alloy has the advantage in particular that the strength of the material is improved.

In one embodiment of the present invention, the light metal material comprises a titanium alloy comprising titanium (Ti) preferably aluminum (Al) and vanadium (V). The light metal material preferably comprises a titanium alloy consisting of titanium (Ti) preferably aluminum (Al) and vanadium (V). More preferably the light metal material comprises TiAl₆V₄ as the titanium alloy.

Due to the production process the aluminum or titanium alloy may contain impurities in the form of other elements.

In one embodiment of the present invention, the aluminum or titanium alloy comprises at least one additional element selected from the group consisting of Zn, Li, Ag Ti, Ta, Co, Cr, Y, La, Eu, Nd, Gd, Tb, Dy, Er, Pr, Ce or mixtures thereof.

For example, the aluminum or titanium alloy comprises the at least one additional element selected from the group consisting of Zn, Li, Ag Ti, Ta, Co, Cr, Y, La, Eu, Nd, Gd, Tb, Dy, Er, Pr, Ce or mixtures thereof in an amount of 0.01 to 1.0% by weight per element based on the total weight of the aluminum or titanium alloy.

Additionally or alternatively, the aluminum or titanium alloy comprises the at least one additional element selected from the group consisting of Zn, Li, Ag Ti, Ta, Co, Cr, Y, La, Eu, Nd, Gd, Tb, Dy, Er, Pr, Ce or mixtures thereof in a maximum total amount of 5.0% by weight, based on the total weight of aluminum or titanium alloy. For example, the aluminum or titanium alloy comprises the at least one additional element selected from the group consisting of Zn, Li, Ag Ti, Ta, Co, Cr, Y, La, Eu, Nd, Gd, Tb, Dy, Er, Pr, Ce or mixtures thereof in a total amount of 0.1 to 5.0% by weight, based on the total weight of the aluminum or titanium alloy.

Another requirement of the present invention is that nanoparticles are distributed in the aluminum or titanium alloy in an amount of 0.1 to 15.0% by weight, based on the total weight of the light metal material.

According to the present invention, “nanoparticles” are particles having particle sizes in the nanometer range to the lower micrometer range. In one embodiment the nanoparticles distributed in the aluminum or titanium alloy comprise particles with a diameter in the range of 10 to 1000 nm. For example, the nanoparticles distributed in the aluminum or titanium alloy comprise particles with a diameter in the range of 15 to 500 nm, more preferably 20 to 250 nm and most preferably 25 to 100 nm. Use of nanoparticles has the advantage that this contributes toward a more homogeneous distribution of the particles in the aluminum or titanium alloy.

For example, the nanoparticles distributed in the aluminum or titanium alloy are non-spherical or mixtures thereof.

In one embodiment of the present invention, the nanoparticles distributed in the aluminum or titanium alloy are spherical. Spherical nanoparticles usually occur at an aspect ratio of 1.0 to 1.1. In another embodiment of the present invention, the nanoparticles distributed in the aluminum or titanium alloy are non-spherical. Non-spherical nanoparticles occur at a different aspect ratio than spherical particles, i.e., the aspect ratio of the non-spherical nanoparticles is not from 1.0 to 1.1. If the nanoparticles are present as non-spherical particles, then the diameter of the particles preferably relates to the smaller dimension.

For the light metal material it is particularly advantageous if the nanoparticles are homogeneously distributed in the aluminum or titanium alloy.

Alternatively, the nanoparticles may be inhomogeneously distributed in the aluminum or titanium alloy.

Another requirement of the present invention is that the light metal material comprises the nanoparticles distributed in the aluminum or titanium alloy in an amount of 0.1 to 15.0% by weight, based on the total weight of the light metal material.

In one embodiment of the present invention, the light metal material comprises the nanoparticles distributed in the aluminum or titanium alloy in an amount of 0.1 to 12.0% by weight, based on the total weight of the light metal material. For example, the light metal material comprises the nanoparticles distributed in the aluminum or titanium alloy in an amount of 0.1 to 10.0% by weight, based on the total weight of the light metal material.

The nanoparticles preferably comprise a material selected from the group consisting of carbon, aluminum oxide, zirconium oxide, yttrium-stabilized zirconium oxide, cerium oxide, lanthanum oxide and mixtures thereof. For example, the nanoparticles consist of a material selected from the group consisting of carbon, aluminum oxide, zirconium oxide, yttrium-stabilized zirconium oxide, cerium oxide, lanthanum oxide and mixtures thereof.

The nanoparticles preferably comprise carbon. In one embodiment of the present invention, the nanoparticles comprise, preferably consist of, carbon selected from the group consisting of fullerenes, carbon nanotubes, graphanes, graphenes, graphites and mixtures thereof. For example, the nanoparticles comprise, preferably consist of, carbons selected from the group consisting of fullerenes, carbon nanotubes, graphanes, graphenes, graphites and mixtures thereof. The use of carbon nanoparticles has the advantage that the resulting light metal material has both an improved strength and improved physical properties such as electrical and thermal conductivity and improved biological properties. In addition, the use of carbon nanoparticles leads to a reduction in the specific density.

According to the present invention the light metal material has a tensile strength of ≧180 MPa, determined at room temperature according to ISO 527-2. For example, the light metal material has a tensile strength in the range of 180 to 1000 MPa at room temperature, determined according to ISO 527-2.

If the light metal material comprises an aluminum alloy, then the light metal material preferably has a tensile strength in the range of 180 to 500 MPa, determined at room temperature according to ISO 527-2. For example, the light metal material has a tensile strength in the range of 180 to 400 MPa, determined at room temperature according to ISO 527-2 when the light metal material comprises an aluminum alloy.

If the light metal material comprises a titanium alloy, then the light metal material preferably has a tensile strength in the range of 500 to 1000 MPa, determined at room temperature according to ISO 527-2. For example, the light metal material has a tensile strength in the range of 700 to 1000 MPa, determined at room temperature according to ISO 527-2 when the light metal material comprises a titanium alloy.

In one embodiment of the present invention, the light metal material additionally has a tensile strength of ≧90 MPa, determined according to ISO 527-2 at a temperature of 250° C.

For example, the light metal material has a tensile strength in a range of 90 to 400 MPa, determined according to ISO 527-2 at a temperature of 250° C.

If the light metal material comprises an aluminum alloy, then the light metal material preferably has a tensile strength in the range of 100 to 350 MPa, determined according to ISO 527-2 at a temperature of 250° C. For example, the light metal material has a tensile strength in the range of 120 to 300 MPa, determined according to ISO 527-2 at a temperature of 250° C. when the light metal material comprises an aluminum alloy.

If the light metal material comprises a titanium alloy, then the light metal material preferably has a tensile strength in the range of 100 to 700 MPa, determined according to ISO 527-2 at a temperature of 250° C. For example, the light metal material has a tensile strength in the range of 200 to 500 MPa, determined according to ISO 527-2 at a temperature of 250° C. when the light metal material comprises a titanium alloy.

Additionally or alternatively, the light metal material has a strain limit Rₚ of ≧150 MPa, determined according to ISO 527-2 at room temperature. For example, the light metal material has a strain limit Rₚ in a range of 150 to 1000 MPa, determined according to ISO 527-2 at room temperature.

If the light metal material comprises an aluminum alloy, then the light metal material preferably has a strain limit Rₚ in the range of 150 to 500 MPa, determined according to ISO 527-2 at room temperature. For example, the light metal material has a strain limit Rₚ in the range of 150 to 400 MPa, determined according to ISO 527-2 at room temperature when the light metal material comprises an aluminum alloy.

If the light metal material comprises a titanium alloy, then the light metal material preferably has a strain limit Rₚ in the range of 500 to 1000 MPa, determined according to ISO 527-2 at room temperature. For example, the light metal material has a strain limit Rₚ in the range of 700 to 1000 MPa, determined according to ISO 527-2 at room temperature when the light metal material comprises a titanium alloy.

Additionally or alternatively, the light metal material has an elongation at break R_{d} of ≧0.1% determined according to ISO 527-2 at room temperature. For example, the light metal material has an elongation at break R_{d} in the range of 0.1 to 20.0% determined according to ISO 527-2 at room temperature.

If the light metal material comprises an aluminum alloy, then the light metal material preferably has an elongation at break R_{d} in the range of 0.1 to 10.0% determined according to ISO 527-2 at room temperature. For example, the light metal material has an elongation at break R_{d} in the range of 0.1 to 6.0% determined according to ISO 527-2 at room temperature when the light metal material comprises an aluminum alloy.

If the light metal material comprises a titanium alloy, then the light metal material preferably has an elongation at break R_{d} in the range of 5.0 to 20.0% determined according to ISO 527-2 at room temperature. For example, the light metal material has an elongation at break R_{d} in the range of 10.0 to 20.0% determined according to ISO 527-2 at room temperature when the light metal material comprises a titanium alloy.

The present invention also relates to a method for producing such a light metal material. The light metal material is preferably produced by a method such as that described below.

The method according to the invention for producing the light metal material as described above comprises at least the steps:

a) Supplying an aluminum or titanium alloy
b) Supplying nanoparticles
c) Bringing the aluminum or titanium alloy from step a) in contact with the nanoparticles from step b) to produce a light metal material comprising the aluminum or titanium alloy and nanoparticles distributed therein and
d) Heat treating the light metal material obtained in step c) in a temperature range of 100 to 1200° C.

The method according to the invention is suitable for producing the above mentioned light metal material and has a low manufacturing cost with simultaneous optimization of the strength values.

According to step a), one requirement of the method according to the invention is thus that an aluminum or titanium alloy is supplied.

With respect to the aluminum or titanium alloy, the additional alloy components and the amounts thereof in the aluminum or titanium alloy, reference is made to the definitions given above with respect to the aluminum or titanium alloy and their embodiments.

The at least one additional alloy component to the aluminum or titanium base alloy is added by the methods known in the prior art. For example, the at least one additional alloy component to the aluminum or titanium base alloy is added in the melt. With the help of this step, the at least one additional alloy component can be distributed homogeneously in the aluminum or titanium base alloy to obtain the aluminum or titanium alloy.

The aluminum or titanium alloy is typically produced in powder or wire form. Alternatively, the aluminum or titanium alloy is supplied as a sintered, cast, rolled, pressed, spray compacted or extruded molded part. Methods of producing alloys in powder or wire form or sintered, cast, rolled, pressed, spray compacted and extruded molded parts are known in the prior art.

Nanoparticles are provided according to step b) of the method according to the invention.

With respect to the nanoparticles and the amounts used in the light metal material, reference is made to the above definitions with respect to the nanoparticles and their embodiments.

The nanoparticles are preferably supplied in the form of a master alloy. For example, the master alloy is an aluminum base master alloy or a titanium base master alloy. The master alloy may comprise the nanoparticles in an amount of 1.0 to 50.0% by weight, based on the total weight of the master alloy. For example, the master alloy comprises the nanoparticles in an amount of 5.0 to 30.0% by weight, based on the total weight of the master alloy.

According to step c), one additional requirement of the method according to the invention is that the aluminum or titanium alloy from step a) is brought in contact with the nanoparticles from step b) to produce a light metal material comprising the aluminum or titanium alloy and nanoparticles distributed therein.

For example, the aluminum or titanium alloy may be brought in contact with the nanoparticles in the form of a master alloy. Bringing the aluminum or titanium alloy in contact with the nanoparticles preferably takes place in the form of a master alloy under a protective gas such as argon. With the help of this step, the nanoparticles may be distributed homogeneously in the aluminum or titanium alloy. In addition, the use of a master alloy has the advantage that the formation of carbidic phases is prevented or at least partially prevented.

The nanoparticles in the form of a master alloy are preferably added to an aluminum or titanium alloy melt.

The aluminum or titanium alloy melt can be produced by means of a plurality of different heat sources. The production of the aluminum or titanium alloy melt preferably takes place by means of a laser beam, an electron beam or an electric arc. However, a chemical exothermic reaction may also be used or the production of the aluminum or titanium alloy melt may take place capacitively, conductively or inductively. Any combination of these heat sources may also be used to produce the aluminum or titanium alloy melt.

Production of the light metal material in step c) takes place according to the methods known in the prior art. For example, the production of the light metal material in step c) takes place by means of a method selected from the group consisting of forging methods, casting methods, powder metallurgical extrusion methods, powder metallurgical generative methods such as additive layer manufacturing (ALM), powder bed methods, laser beam methods, electron beam methods, laser powder methods or laser jet methods and non-powder metallurgy methods such as, for example, wire methods or plasma wire methods. These methods are known in the prior art.

Another requirement of the method according to the invention is that the light metal material obtained in step c) is subjected to a heat treatment in a temperature range of 100 to 1200° C. The light metal material obtained in step c) is preferably subjected to a heat treatment in a temperature range of 100 to 1200° C., depending on the base alloy. For example, the light metal material obtained in step c) is subjected to a heat treatment in a temperature range of 100 to 550° C. when the base alloy is an aluminum alloy. Alternatively, the light metal material obtained in step c) is subjected to a heat treatment in a temperature range up to 1200° C. when the base alloy is a titanium alloy.

In one embodiment of the present invention, the heat treatment according to step d) of the method according to the invention is carried out in a temperature range of 100 to 1200° C., for example, in a temperature range of 100 to 550° C. in the case of an aluminum base alloy or in a temperature range of 500 to 1200° C. in the case of a titanium base alloy for a period of 10 min to 50 h. The heat treatment may typically be carried out at temperatures between 100 and 1200° C., for example, in a temperature range of 100 to 550° C. in the case of an aluminum base alloy or in a temperature range of 500 to 1200° C. in the case of a titanium base alloy for a period of 10 min to 10 h. For example, the heat treatment takes place at temperatures between 100 and 1200° C., for example, in a temperature range from 100 to 550° C. in the case of an aluminum base alloy or in a temperature range of 500 to 1200° C. in the case of a titanium base alloy for a period of 10 min to 5 h or for a period of 30 min to 3 h., for example, the heat treatment may be carried out under air, protective gas or in vacuo, for example, in vacuo. The heat treatment according to step d) of the method according to the invention may also be carried out multiple steps and/or in increments. For example, the heat treatment according to step d) of the method according to the invention is carried out under a protective gas such as nitrogen or argon at temperatures between 100 and 1200° C., for example, at temperatures between 100 and 550° C. in the case of an aluminum base alloy or in a temperature range of 500 to 1200° C. in the case of a titanium base alloy for a period of 30 min to 3 h.

Methods for heat treating light metal materials in a temperature range of 100 to 1200° C. are known in the prior art. This heat treatment improves the material properties of the light metal material because inherent stresses in the material are dissipated.

In one embodiment of the present invention, the heat treatment according to step d) of the method according to the invention is carried out directly following step c), i.e., the heat treatment according to step d) of the method according to the invention is carried out directly with the light metal material obtained in step c). In other words the method according to the invention is carried out without one or more additional method steps between the method steps c) and d).

In one embodiment of the present invention, the heat-treated light metal material obtained in step d) may be subjected to a cooling.

For example, the heat-treated light metal material obtained in step d) may be cooled to room temperature.

In one embodiment of the present invention, the heat-treated light metal material obtained in step d) is cooled to room temperature at a cooling rate amounting to ≧10 K/sec, preferably ≧10 to 20 K/sec. For example, the heat-treated light metal material may be cooled to room temperature at a cooling rate in the range of ≧20 K/sec or in the range of 20 K/sec to 1000 K/sec.

Such methods of cooling heat-treated light metal materials are known in the prior art. For example, a defined cooling of the heat-treated light metal material to room temperature may take place with the help of a cooling of moving air or by quenching in water.

Alternatively, the heat-treated light metal material obtained in step d) is cooled to room temperature in air.

Because of the advantages offered by the light metal material according to the invention, the present invention also relates to the use of the light metal material as a piston component in a rotary piston engine. For example, the light metal material according to the invention is used as a piston component in a rotary piston engine in a drive or a turbine in a passenger transportation vehicle, in particular in an airplane, such as a passenger airplane and unmanned aircraft. As explained above, pistons for rotary piston engines having a high strength can be produced from the light metal material according to the invention.

To absorb the mechanical forces and/or torques in rolling of the eccentric shaft on the inside of a light metal piston over the long term, it is necessary for a material of a higher strength than the light metal material according to the invention may be used on the inside of the piston. To do so, an inlay (cast or forged part or a component produced generatively) is fabricated from an iron or nickel base alloy that has the required gearing with respect to the eccentric shaft of the rotary piston engine. This inlay component is preferably connected to the cover piston of the light metal material according to the invention by means of friction welding, which leads to a good connection of the two light metal materials. As an alternative, diffusion welding may also be considered, but that includes longer process times. In addition, the internal gearing is hardened by annealing or carburizing and is additionally provided with far-reaching inherent compressive stresses by blasting with beads or by laser shock treatment.

With regard to thermomechanical stability and in particular the stability in the case of titanium pistons with respect to hot gas corrosion, it is necessary to take corresponding measures on the exterior side of the piston to also allow the creation of grooves for the sealing strips (sealing with respect to the trochoid). To do so, a sufficiently thick layer consisting of either iron or nickel base alloy may be applied to the light metal material according to the invention (thickness of the layer between 1 mm and 20 mm) by means of a generative method such as laser-wire or plasma-wire methods. These alloys already have a very much lower thermal conductivity than the light metal material according to the invention and thus function here as both thermal insulation layer and also as a hot gas corrosion protective layer. Because of the high specific density (approx. 8 g/cm³ in the case of Fe base alloys, approx. 9 g/cm³ in the case of Ni base alloys) in comparison with aluminum alloys (approx. 2.3-2.7 g/cm³) or titanium alloys (approx. 4.3-4.5 g/cm³), there is an additional advantage here with regard to the moment of inertia of the entire piston (flywheel mass) which has positive effects with regard to minimization of torque fluctuations. In conclusion, to further reduce the thermal burden of the light metal material according to the invention, an oxidic thermal insulation layer (e.g., zirconium oxide, yttrium-stabilized zirconium oxide, YSZ or lanthanum hexaaluminate or mixtures of the individual oxides/mixed oxides) may be applied. This preferably takes place by means of a generative method such as plasma spraying, flame spraying/high-speed flame spraying or laser powder application.

As an alternative to the differential structure of the entire piston in multiple method steps as described above, it is also possible to produce the entire piston by exclusively generative methods. The powder bed method is particularly suitable for this. For example, the light metal material base piston is therefore produced from a corresponding powder bed. Following that, the Fe or Ni gearing component is applied by means of an additional powder bed and then brought to the final dimensions subsequently by mechanical or electrochemical methods and also hardened (e.g., plasma nitriding and/or laser shock peening).

In another step the piston exterior regions can be produced generatively accordingly.

### EXAMPLES

The aluminum and/or titanium alloys listed in Table 1 were produced according to the method indicated:

TABLE 1

| Alloy | Method for producing the alloy |
|---|---|
| AlSi₁₂CuMgNi | cast |
| | pressed |
| AlSi₁₈CuMgNi | cast |
| | pressed |
| AlSi₁₂Cu₄Ni₂Mg | cast |
| AlSi₁₇Cu₄Mg | cast |
| AlSi₂₀Fe₅Ni₂ | spray compacted |
| AlSi₂₅Cu₄Mg | spray compacted |
| TiAl₆V₄ | cast |

The alloys listed in Table were investigated with regard to the tensile strength Rₘ, strain limit Rₚ and elongation at break R_{d}. The results are shown in Table 2.

TABLE 2

| | Method for | Temper- | | | |
|---|---|---|---|---|---|
| | producing | ature | R_{p0.2} | Rₘ | R_{d} |
| Alloy | the alloy | (° C.) | (MPa) | (MPa) | (MPa) |
| AlSi₁₂CuMgNi | cast | RT | 190-230 | 200-250 | 0.3-1.5 |
| | pressed | RT | 280-310 | 300-370 | 1-3 |
| | cast | 250 | 80-110 | 100-150 | — |
| | pressed | 250 | 90-120 | 110-170 | — |
| | cast | 300 | 50-80 | 80-100 | — |
| AlSi₁₈CuMgNi | cast | RT | 170-200 | 180-230 | 0.2-1 |
| | pressed | RT | 220-280 | 230-300 | 0.5-1.5 |
| | cast | 250 | 90-125 | 110-140 | — |
| | pressed | 250 | 90-125 | 100-160 | — |
| | cast | 300 | 60-80 | 90-130 | — |
| AlSi₁₂Cu₄Ni₂Mg | cast | RT | 200-280 | 210-290 | 0.1-0.5 |
| | cast | 250 | 100-150 | 130-180 | — |
| | cast | 300 | 85-100 | 100-120 | — |
| AlSi₁₇Cu₄Mg | cast | RT | 210-230 | 180-220 | 0.2-1 |
| AlSi₂₀Fe₅Ni₂ | spray | RT | 240 | 360 | 2 |
| | compacted | | | | |
| AlSi₂₅Cu₄Mg | spray | RT | 180 | 250 | 1 |
| | compacted | | | | |
| TiAl₆V₄ | cast | RT | 880 | 950 | 14 |

RT: Room temperature
R_{p0.2}: Strain limit, determined according to ISO 527-2
Rₘ: Tensile strength, determined according to ISO 527-2
R_{d}: Elongation at break, determined according to ISO 527-2

As Table 2 indicates, the light metal material according to the invention has a tensile strength of ≧180 MPa, determined according to ISO 527-2 at room temperature. In addition, the light metal material according to the invention has a tensile strength of ≧90 MPa, determined according to ISO 527-2 at a temperature of 250° C.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-14. (canceled)

15. A light metal material, comprising:
a) an aluminum or titanium alloy; and
b) nanoparticles distributed in the aluminum or titanium alloy in an amount of 0.1 to 15.0% by weight, based on the total weight of the light metal material,
wherein the light metal material has a tensile strength at room temperature of ≧180 MPa, determined according to ISO 527-2.

16. The light metal material of claim 15, wherein:
a) the aluminum alloy comprises, as an additional alloy component, at least one component selected from the group consisting of silicon (Si), scandium (Sc), copper (Cu), magnesium (Mg), nickel (Ni), iron (Fe), vanadium (V), titanium (Ti), zirconium (Zr), ytterbium (Y), manganese (Mn), hafnium (Hf), niobium (Nb), tantalum (Ta) or mixtures thereof, or
b) the titanium alloy comprises, as an additional alloy component, at least one component selected from the group consisting of aluminum (Al), vanadium (V) or mixtures thereof.

17. The light metal material of claim 15, wherein the light metal material is an aluminum alloy comprising aluminum (Al), magnesium (Mg), and silicon (Si).

18. The light metal material of claim 15, wherein the nanoparticles have a diameter of 10 to 1000 nm.

19. The light metal material of claim 15, wherein the nanoparticles have a diameter of 15 to 500 nm.

20. The light metal material of claim 15, wherein the nanoparticles have a diameter of 20 to 250 nm.

21. The light metal material of claim 15, wherein the nanoparticles have a diameter of 25 to 100 nm.

22. The light metal material of claim 15, wherein the light metal material comprises the nanoparticles in an amount of 0.1 to 12.0% by weight, based on the total weight of the light metal material.

23. The light metal material of claim 15, wherein the nanoparticles comprise a material selected from the group consisting of carbon, aluminum oxide, zirconium oxide, yttrium-stabilized zirconium oxide, cerium oxide, lanthanum oxide and mixtures thereof.

24. The light metal material of claim 23, wherein the nanoparticles comprising carbon are selected from the group consisting of fullerenes, carbon nanotubes, graphanes, graphenes, graphites, and mixtures thereof.

25. The light metal material of claim 15, wherein the light metal material has a tensile strength of ≧90 MPa, determined according to ISO 527-2 at a temperature of 250° C.

26. A method for producing a light metal material, the method comprising
a) providing an aluminum or titanium alloy;
b) providing nanoparticles in an amount of 0.1 to 15.0% by weight, based on the total weight of the light metal material;
c) bringing the aluminum or titanium alloy from step a) in contact with the nanoparticles from step b) to produce a light metal material comprising the aluminum or titanium alloy and nanoparticles distributed therein; and
d) heat treating the light metal material obtained in step c) in a temperature range of 100 to 1200° C.,
wherein the light metal material has a tensile strength at room temperature of ≧180 MPa, determined according to ISO 527-2.

27. The method of claim 26, wherein the production of the light metal material in step c) is carried out by a method selected from the group consisting of forging methods, casting methods, powder metallurgy extrusion methods, powder metallurgy generative methods such as additive layer manufacturing (ALM), powder bed methods, laser beam methods, electron beam methods, laser powder methods or laser jet methods, and non-powder metallurgy methods including laser wire methods or plasma wire methods.

28. The method of claim 26, wherein the heat treatment from step d) is carried out under a protective gas or in vacuo for a period of 10 min to 50 h, or in at least multiple steps or increments.

29. The method of claim 26, wherein the light metal material is part of a piston component in a rotary piston engine.

30. The method of claim 29, wherein the rotary piston engine is part of a drive or a turbine in a passenger airplane or unmanned aircraft.
